(19) United States
(12) Patent Application Publication
(10) Pub. No.: US 2014/0101030 A1
(43) Pub. Date: Apr. 10, 2014

(54) Payment Template Page Queue for a Mobile Device

(71) Applicant: BANK OF AMERICA CORPORATION, Charlotte, NC (US)

(72) Inventors: Milton Santiago, JR., Chicago, IL (US); Christopher Hope, Kent (GB); Darin Garitt Mallory, Plainfield, IL (US); Savit Pirl, Bolingbrook, IL (US); Mary R. Rosendahl, Wilmette, IL (US); Daniel Marsh Whipple, Harrisburg, NC (US)

(73) Assignee: Bank of America Corporation, Charlotte, NC (US)

(21) Appl. No.: 13/647,803

(22) Filed: Oct. 9, 2012

(51) Int. Cl. G06Q 20/22

(52) U.S. Cl. 705/39

(57) ABSTRACT

In an exemplary embodiment, a method includes displaying a plurality of payment template summaries simultaneously on a mobile device. A selection of two or more of the plurality of payment template summaries is received. A queue comprising a plurality of payment template pages is generated according to the selection. A payment template page comprises a plurality of payment details associated with a payment template that corresponds to a selected payment template summary. A first payment template page of the plurality of payment template pages of the queue is displayed on the mobile device. A monetary amount is received at the first payment template page from a user of the mobile device and an initiated payment for the monetary amount is generated. The initiated payment includes the plurality of payment details of the first payment template page.

### TECHNICAL FIELD OF THE INVENTION

This invention relates generally to payment processing and, more specifically, to a payment template page queue for a mobile device.

### BACKGROUND OF THE INVENTION

A mobile device may facilitate payment processing. For example, a user of the mobile device may perform payment initiation, payment approval, or payment rejection using a browser or dedicated application of the mobile device. The mobile device may receive payment information from an enterprise. The mobile device may communicate user input received via the browser or dedicated application to the enterprise. The enterprise may process the payments according to the user input.

### SUMMARY OF THE INVENTION

In accordance with the teachings of the present disclosure, disadvantages and problems associated with processing payment transactions may be reduced or eliminated.

According to an exemplary embodiment, a method includes displaying a plurality of payment template summaries simultaneously on a mobile device. A payment template summary corresponds to a payment template and includes a subset of a plurality of payment details associated with the payment template. A selection of two or more of the plurality of payment template summaries is received. A queue comprising a plurality of payment template pages is generated according to the selection. A payment template page comprises the plurality of payment details associated with the payment template that corresponds to a selected payment template summary. A first payment template page of the plurality of payment template pages of the queue is displayed on the mobile device. A monetary amount is received at the first payment template page from a user of the mobile device and an initiated payment for the monetary amount is generated. The initiated payment includes the plurality of payment details of the first payment template page.

Certain embodiments of the invention may provide one or more technical advantages. A technical advantage of one embodiment includes efficient communication between a mobile device and an enterprise by transmission of initiated payments in groups. Another advantage includes queuing a plurality of payment template pages to facilitate payment initiation. Another advantage includes loading information from multiple different application programming interface (API) calls into a single payment template page. Another advantage includes reducing network bandwidth used by extraneous submissions by immediately notifying a user that a group of initiated payments has been submitted to an enterprise.

Certain embodiments of the present disclosure may include none, some, or all of the above technical advantages. One or more other technical advantages may be readily apparent to one skilled in the art in view of the figures, descriptions, and claims of the present disclosure.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example system that facilitates the generation of a payment action page queue and a payment template page queue for a mobile device;

FIG. 2 illustrates an example method for facilitating the generation of a payment action page queue that may be performed by a mobile device of FIG. 1;

FIGS. 3A-3D illustrate example pages that may be displayed by a mobile device of FIG. 1 in connection with the generation of a payment action page queue;

FIG. 4 illustrates an example method for facilitating the generation of a payment template page queue that may be performed by a mobile device of FIG. 1; and

FIGS. 5A-5D illustrate example pages that may be displayed by a mobile device of FIG. 1 in connection with the generation of a payment template page queue.

### DETAILED DESCRIPTION OF THE INVENTION

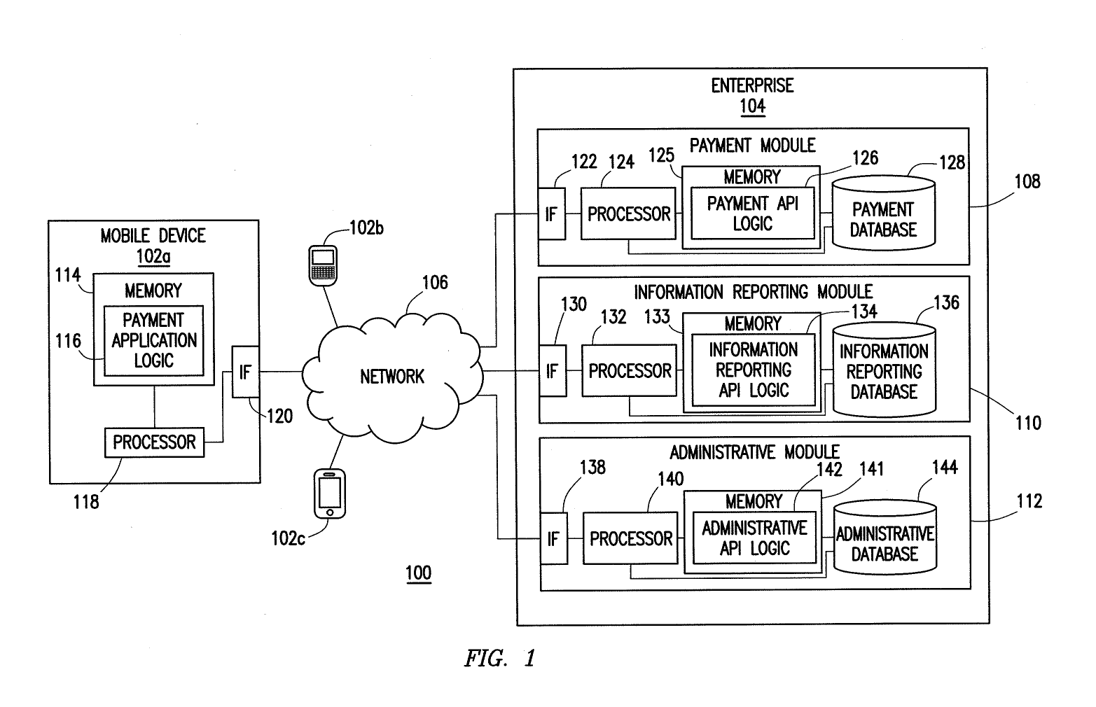

Embodiments of the present invention and its advantages are best understood by referring to FIGS. 1 through 5, like numerals being used for like and corresponding parts of the various drawings.

FIG. 1 illustrates an example system 100 that facilitates generation of payment action page queues and payment template page queues for mobile devices 102. System 100 includes one or more mobile devices 102 that communicate over one or more networks 106 with enterprise 104 to facilitate processing of payments.

In various embodiments, a mobile device 102 receives payment information from enterprise 104. In particular embodiments, mobile device 102 receives initiated payments that are awaiting approval to be paid. The user of mobile device 102 may have the authority to apply a payment action to one or more of the initiated payments. For example, the user may approve the payment, reject the payment, delete the payment, or prompt another user to action the payment. In particular embodiments, mobile device 102 displays a summary page including a few details of each initiated payment. From this summary page, the user may apply actions to the initiated payments. However, in certain situations, additional details regarding an initiated payment may aid the user in making a quick and accurate assessment of which payment action should be applied to a payment. In particular embodiments, mobile device 102 generates a queue of payment action pages in response to user input. Each payment action page corresponds to a payment and includes detailed information regarding the payment. In some embodiments, each payment action page includes the details shown in the summary page and additional details regarding the corresponding payment. The user may iterate through the payment action pages and apply actions to each initiated payment. When the user is finished, mobile device 102 may submit the payment actions to enterprise 104 for further processing. Such embodiments may enable a user to apply actions more quickly and accurately to the initiated payments in comparison to applications in which the user must action the payments from a summary page or is not able to iterate through detailed views of the payments.

In various embodiments, mobile device 102 receives payment templates from enterprise 104. The templates may be displayed by mobile device 102 in a summary page that lists a few details about the payment template. The user may select multiple templates from the summary page. In response to the selection, mobile device 102 may generate a queue of payment template pages. Each payment template page includes information about the payment template. In various embodiments, a payment template page includes all of the information about the payment template that is shown in the summary page and additional information about the payment template. The user may iterate through the payment template pages of the queue and initiate payments by entering monetary amounts for the payments in the payment template pages. When the user is finished, mobile device 102 may submit the initiated payments to enterprise 104 for further processing. For example, the initiated payments may be sent to one or more individuals for payment actioning. Such embodiments may enable a user to initiate payments more quickly in comparison to applications that only allow a user to initiate payments one at a time.

System 100 includes mobile devices 102a-102c. In various embodiments, there may be any suitable number of mobile devices 102 that communicate with enterprise 104 through network 106. Mobile device 102 may include a wireless or cellular telephone (e.g., a smartphone); a netbook, tablet, or slate personal computer; a personal digital assistant; or any other portable device capable of receiving, processing, storing, and/or communicating information with other components of system 100. Mobile device 102 may also comprise a user interface, such as a display, touch screen, keyboard, mouse, or other appropriate terminal equipment. In particular embodiments, mobile device 102 connects to network 106 via a cellular or other wireless connection.

Mobile device 102 may be operated by a customer or a user associated with a customer of enterprise 104. A customer may maintain one or more accounts with enterprise 104. The customer may be an individual or an organization comprising multiple individuals, such as a business. An account may be a credit card account, a debit card account, a savings account, a checking account, a business account, or any other account. An account may be associated with enterprise 104. For example, enterprise 104 may maintain the account, store records of transactions involving the account, transfer money to and from the account, or perform other operations associated with the account. An account may enable a customer to purchase goods or services with funds or credit associated with the customer's account.

Network 106 represents any suitable network operable to facilitate communication between the components of system 100, such as mobile devices 102 and enterprise 104. Network 106 may include any interconnecting system capable of transmitting audio, video, signals, data, messages, or any combination of the preceding. Network 106 may include all or a portion of a public switched telephone network (PSTN), a cellular network, a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

Enterprise 104 may represent any individual, business, or organization. One example of an enterprise may include a financial institution. A financial institution may include any business or organization that engages in financial activities, which may include, but are not limited to, banking and investment activities such as maintaining accounts (e.g., transaction accounts, savings accounts, credit accounts, investment accounts, insurance accounts, portfolios, etc.), receiving deposits, crediting accounts, debiting accounts, extending credit to account holders, purchasing securities, providing insurance, and supervising a customer's portfolio.

A financial institution may provide a variety of financial products and services. Examples of financial products and services may include, but are not limited to, account services such as maintaining accounts, receiving deposits, crediting accounts, debiting accounts, extending credit, purchasing securities, providing insurance, and portfolio management.

A financial institution may provide financial products and services to customers. For example, a financial institution may maintain an account for a customer. The customer may perform a variety of activities using the account, including contributing funds to the account, withdrawing funds from the account, managing the account, and being responsible or liable for account transactions (e.g., purchases).

In the embodiment depicted, mobile device 102a includes one or more interfaces 120, one or more processors 118, and one or more memories 114 that collectively facilitate generation of payment action page queues and payment template page queues by mobile device 102a. Mobile devices 102b and 102c may include similar components.

Network interface 120 represents any suitable device operable to receive information from network 106, transmit information through network 106, perform processing of information, communicate with other devices, or any combination of the preceding. For example, network interface 120 receives payment information, such as information about initiated payments or payment template information from enterprise 104 through network 106. As another example, network interface 120 may communicate payment information such as initiated payments or actions associated with initiated payments to enterprise 104. Network interface 120 represents any port or connection, real or virtual, including any suitable hardware and/or software, including protocol conversion and data processing capabilities, to communicate through a LAN, WAN, or other communication system that allows mobile device 102a to exchange information with enterprise 104 or other components of system 100.

Processor 118 communicatively couples to network interface 120 and memory 114 and controls the operation and administration of mobile device 102a by processing information received from network interface 120 and memory 114. Processor 118 includes any hardware and/or software that operates to control and process information. For example, processor 118 executes payment application logic 116 to control the operation of mobile device 102a. Processor 118 may be a programmable logic device, a microcontroller, a microprocessor, any suitable processing device, or any suitable combination of the preceding.

Memory 114 stores, either permanently or temporarily, data, operational software, or other information for processor 118. Memory 114 includes any one or a combination of volatile or non-volatile local or remote devices suitable for storing information. For example, memory 114 may include Random Access Memory (RAM), Read Only Memory (ROM), magnetic storage devices, optical storage devices, or any other suitable information storage device or a combination of these devices. In the illustrated embodiment, memory 114 includes payment application logic 116. Payment application logic 116 generally refers to logic, rules, algorithms, code, tables, and/or other suitable instructions embodied in a computer-readable storage medium for performing the described functions and operations of mobile device 102a. While illustrated as including a particular module, memory 114 may include any suitable information for use in the operation of mobile device 102a.

In the embodiment depicted, enterprise 104 includes payment module 108, information reporting module 110, and administrative module 112. These modules each represent any suitable components that facilitate the operation of enterprise 104 by facilitating communication with mobile devices 102 and facilitating generation of payment action page queues and payment template page queues when appropriate. Each module may include a network server, any suitable remote server, a mainframe, a host computer, a workstation, a web server, a personal computer, a file server, or any other suitable device operable to communicate with mobile devices 102 and process data. In some embodiments, the modules may execute any suitable operating system such as IBM's zSeries/Operating System (z/OS), MS-DOS, PC-DOS, MAC-OS, WINDOWS, UNIX, OpenVMS, or any other appropriate operating system, including future operating systems. The functions of the modules 108, 110, and 112 may be performed by any suitable combination of one or more servers or other components at one or more locations. In an embodiment where a module is a server, the server may be a private server, and the server may be a virtual or physical server. The server may include one or more servers at the same or remote locations. Also, the modules may include any suitable component that functions as a server.

In particular embodiments, each module 108, 110, or 112 may provide a subset of the information used to generate payment action pages and/or payment template pages to mobile device 102. The information provided by payment module 108 may be retrieved from payment database 128, the information provided by. information reporting module 110 may be retrieved from information reporting database 136, and the information provided by administrative module 112 may be retrieved from administrative database 144. In particular embodiments, payment module 108 provides information about an initiated payment or a payment template, such as a recipient of the payment, a payment amount, a value date and cut-off time, an initiator of the payment, an identifier of an account from which payment is to be made, notes associated with the payment, a transaction number associated with the payment, a transfer type, a template name, a sender reference number, or other suitable information associated with the payment. In particular embodiments, information reporting module 110 provides account balance information and any other suitable information and administrative module 112 provides contact information of individuals or entities associated with an initiated payment or a payment template and any other suitable information. In other embodiments, the information used to generate payment action pages and payment template pages may be distributed among the modules 108, 110, and 112 in any suitable manner.

In particular embodiments, each module implements its own API. When mobile device 102a requests information from a particular module, it calls the API implemented by that module. In particular embodiments, API calls to payment module 108 are sent to a first Uniform Resource Locator (URL), API calls to information reporting module 110 are sent to a second URL, and API calls to administrative module 112 are sent to a third URL. In other embodiments, API calls for the different modules may be sent to the same URL and passed to the relevant modules for processing.

Each module includes components that facilitate the operation of the module. For example, payment module 108 includes one or more interfaces 122, one or more processors 124, one or more memories 125, and payment database 128 that collectively facilitate generation of payment action page queues and payment template page queues for mobile devices 102. For purposes of explanation, only the components of payment module 108 are described in detail herein. However, the corresponding components of information reporting module 110 and administrative module 112 may perform similar functions.

Network interface 122 represents any suitable device operable to receive information from network 106, transmit information through network 106, perform processing of information, communicate with other devices, or any combination of the preceding. For example, network interface 122 may receive API calls requesting payment information from mobile devices 102 and communicate the requested information to mobile devices 102. Network interface 122 represents any port or connection, real or virtual, including any suitable hardware and/or software, including protocol conversion and data processing capabilities, to communicate through a LAN, WAN, or other communication system that allows enterprise 104 to exchange info nation with mobile devices 102 or other components of system 100.

Processor 124 communicatively couples to network interface 122, memory 125, and payment database 128, and controls the operation and administration of payment module 108 by processing information received from network interface 122, memory 125, and payment database 128. Processor 124 includes any hardware and/or software that operates to control and process information. For example, processor 124 executes payment API logic 126 to perform requests from API calls and otherwise control the operation of payment module 108. Processor 124 may be a programmable logic device, a microcontroller, a microprocessor, any suitable processing device, or any suitable combination of the preceding.

Memory 125 stores, either permanently or temporarily, data, operational software, or other information for processor 124. Memory 125 includes any one or a combination of volatile or non-volatile local or remote devices suitable for storing information. For example, memory 125 may include RAM, ROM, magnetic storage devices, optical storage devices, or any other suitable information storage device or a combination of these devices. In the illustrated embodiment, memory 125 includes payment API logic 126. Payment API logic 126 generally refers to logic, rules, algorithms, code, tables, and/or other suitable instructions embodied in a computer-readable storage medium for performing the described functions and operations of payment module 108. While illustrated as including a particular module, memory 125 may include any suitable information for use in the operation of payment module 108.

Payment database 128 stores, either permanently or temporarily, payment information used during the generation of payment action pages and payment template pages by mobile devices 102. Payment database 128 may also store payments initiated by mobile devices 102 and payment actions applied to initiated payments by mobile devices 102. Payment database 128 includes any one or a combination of volatile or non-volatile local or remote devices suitable for storing information. For example, payment database 128 may include RAM, ROM, magnetic storage devices, optical storage devices, or any other suitable information storage device or combination of these devices.

A component of system 100 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 100 without departing from the scope of the invention. For example, system 100 may include any number of mobile devices 102, networks 106, and enterprises 104. Any suitable logic may perform the functions of system 100 and the components within system 100.

In operation, mobile device 102 is operable to identify a plurality of initiated payments awaiting approval. The initiated payments may each be associated with payment details describing the particular initiated payment. Mobile device 102 is operable to generate a queue comprising a plurality of payment action pages. Each payment action page may correspond to an initiated payment and may include the payment details describing the corresponding initiated payment. Mobile device 102 is further operable to display a first payment action page of the queue and to subsequently display a second payment action page of the queue in response to receiving a payment action associated with the first payment action page from the user of mobile device 102.

In operation, mobile device 102 is further operable to display a plurality of payment template summaries simultaneously. A payment template summary corresponds to a payment template and includes a subset of a plurality of payment details associated with the payment template. The mobile device 102 is operable to receive a selection of two or more of the plurality of payment template summaries and to generate a queue of payment template pages according to the selection. A payment template page comprises the plurality of payment details associated with the payment template that corresponds to a selected payment template summary. The mobile device 102 is operable to display a first payment template page of the queue, to receive a monetary amount at the first payment template page from a user of mobile device 102, and to initiate a payment for the monetary amount. The initiated payment includes the plurality of payment details of the first payment template page.

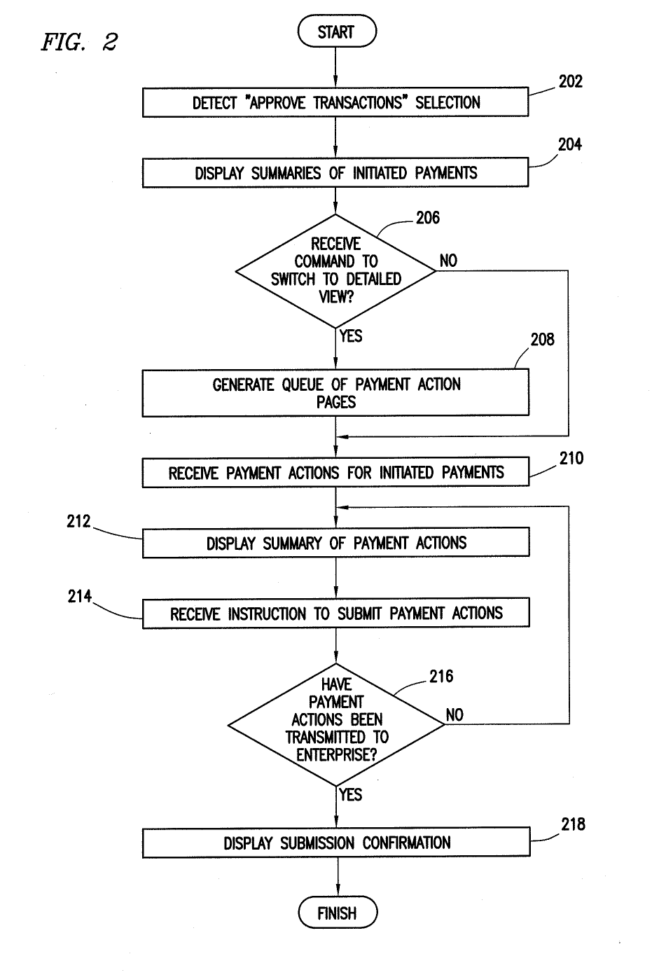

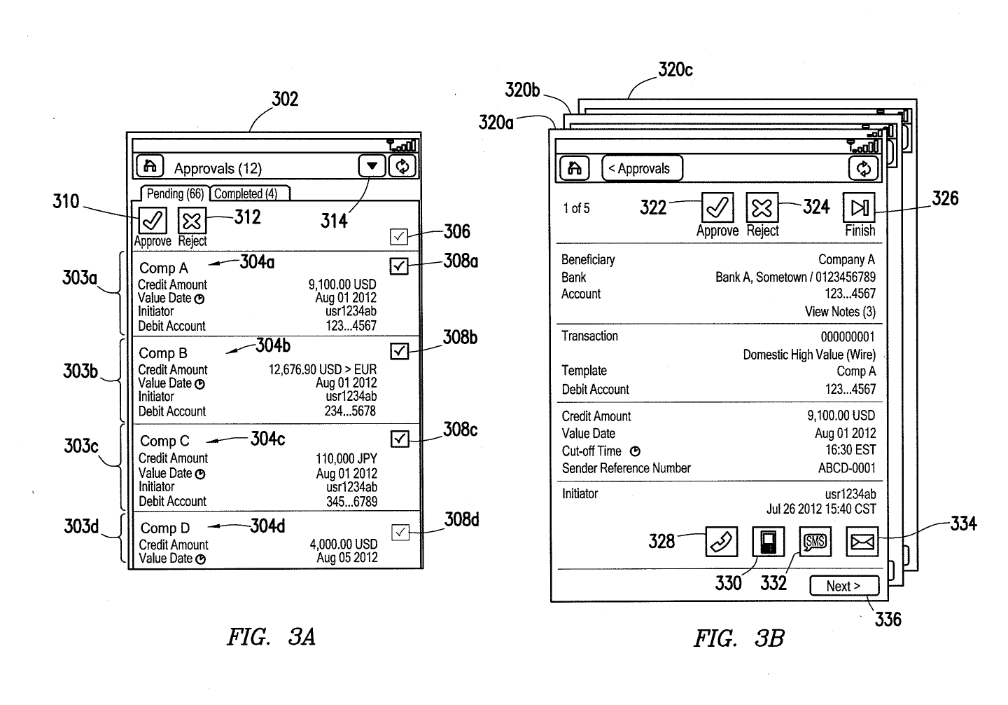

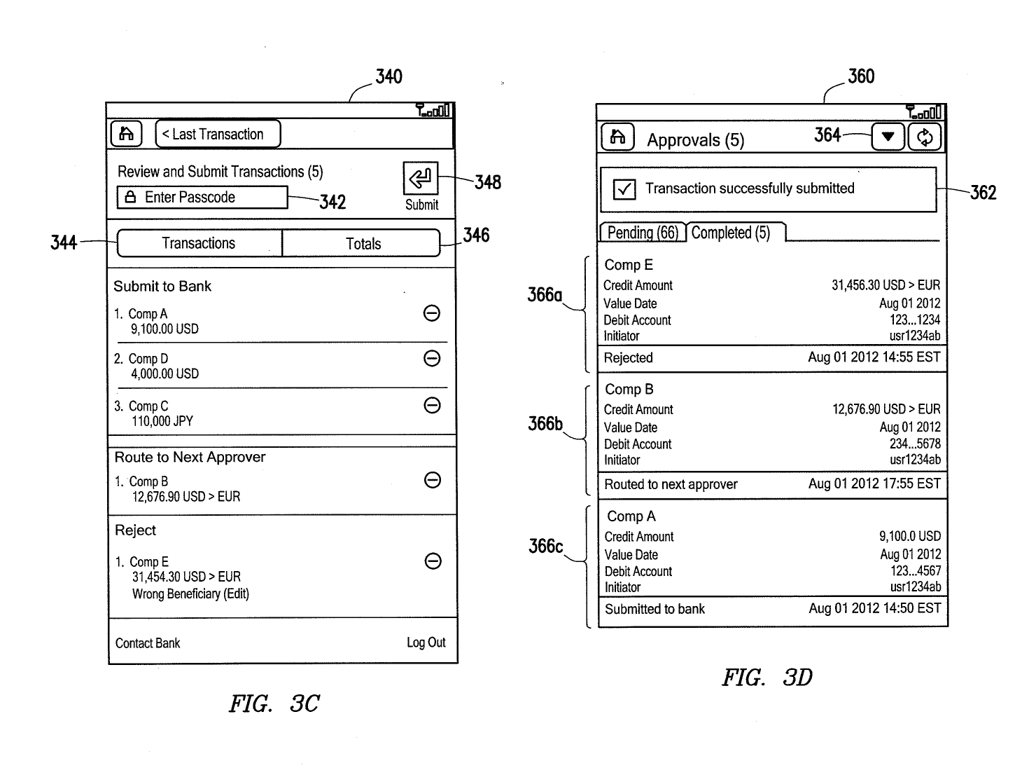

FIG. 2 illustrates an example method for facilitating the generation of a payment action page queue that may be performed by mobile device 102. The method will be explained in connection with FIGS. 3A-3D which illustrate example pages that may be displayed by mobile device 102. The method begins at step 202, where an “approve transactions” selection is detected. In particular embodiments, mobile device 102 executes a mobile banking application (e.g., via a web browser or dedicated application) that allows a user to select various mobile banking functions, including an “approve transactions” function. The user may select the function in any suitable manner, such as through touching or clicking a button corresponding to the function. Upon selection of the “approve transactions” function, mobile device 102 may identify initiated payments that are awaiting approval. The mobile device 102 may identify these payments in any suitable manner. In particular embodiments, the mobile device may send one or more API calls requesting the initiated payments to enterprise 104 in response to the selection of the “approve transactions” function. Enterprise 104 may then transmit the initiated payments to mobile device 102. In other embodiments, the initiated payments may be received from enterprise 104 prior to the selection. In particular embodiments, the identified payments are associated with a user of mobile device 102. For example, the payments identified may be payments over which the user has authority. As an example, the user may be a member of an organization and may have authority to approve or reject the identified payments. In particular embodiments, an API call requesting the initiated payments may include an identifier of the user such that enterprise 104 may return the appropriate payments to mobile device 102.

At step 204, summaries of the identified initiated payments are displayed. For example, mobile device 102 may display the summaries in a page such as summary page 302 of FIG. 3A. Summary page 302 includes summaries 303a-303d of initiated payments. Summary page 302 may include any suitable number of summaries 303. In the embodiment depicted, additional summaries 303 may be viewed by scrolling down on summary page 302. Each summary 303 includes a subset of details associated with the corresponding initiated payment. For example, in the embodiment depicted, summary 303a includes a name 304a of a template “Comp A” used to create the payment. Any suitable template name be used. In some embodiments, the template name 304 indicates the recipient of the payment. For example, in the depicted embodiment, “Comp A” may indicate that Company A is the recipient of the payment. Summary 303a also includes an amount of the payment, depicted as a “Credit Amount.” Summary 303a further includes a value date of the payment. The value date indicates the date at which the payment funds will be available to the payment recipient. Summary 303a may also include an icon to indicate whether a payment is urgent. For example, in summary 303a, a clock is shown next to the value date. In various embodiments, the clock may have different colors, depending on the amount of time left to approve a payment such that the payment will be available to the recipient by the displayed value date. For example, a red clock may indicate a short amount of time, a yellow clock may indicate a moderate amount of time, and a green clock may indicate a large amount of time. Summary 303a may also include the initiator of the payment and an account from which the payment is to be made. Although summaries 303 depict particular details associated with the initiated payments, any subset of available details may be depicted in the summaries. Summaries 303 may be displayed in any suitable order. In the embodiment depicted, a user may select an ordering button 314 and choose a desired order from a pull-down menu. For example, summaries 303 may be displayed in order of payment amount, value date, payment recipient, debit account, initiator, or other suitable detail associated with the corresponding payments.

At step 206, it is determined whether a command to switch to a detailed view has been received. If a command to switch to a detailed view has not been received, the mobile device continues displaying summary page 302. If the command has been received, the method proceeds to step 208 where a queue of payment action pages is generated. Any suitable command may be used to switch to a detailed view. For example, summary page 302 may include a button that may be selected to switch to the detailed view. As another example, a user may select any of the template names 304 to switch to the detailed view.

An example queue of payment action pages 320a-320c is depicted in FIG. 3B. Each payment action page 320 corresponds to an initiated payment and includes a detailed view of the details associated with the payment. In particular embodiments, a payment action page 320 is created for each initiated payment that is awaiting actioning from the user of mobile device 102. Accordingly, in some embodiments, a payment action page 320 may be created for each summary 303 of summary page 302. In other embodiments, a payment action page 320 is created for each summary 303 of summary page 302 that is selected by the user via selection boxes 308 or other suitable means. In accordance with such an embodiment, the queue of FIG. 3B includes three payment action pages 320.

In particular embodiments, the payment action pages 320 include payment details associated with the initiated payment that are not included in the corresponding summary 303. In particular embodiments, payment action pages 320 include all of the details included in summaries 303 in addition to other details associated with the corresponding payments.

As in the example summaries 303 described above, payment action pages 320 may include a name of the template used to create the payment, an amount of the payment, a value date of the payment, an icon indicating the urgency of the payment, the initiator of the payment, and an account from which the payment is to be made. A payment action page 320 may also include a separate field for a recipient of the payment, an address of the recipient, other contact information of the recipient, a balance of the account from which the payment is to be made, an enterprise (e.g., a bank) that maintains the account from which the payment is to be made, miscellaneous notes regarding the payment entered by an individual associated with the payment, a transaction number of the payment, a transfer type of the payment, (e.g., domestic high value (wire), low value wire (e.g., Automated Clearing House (ACH)), Society for Worldwide Interbank Financial Telecommunications (SWIFT) payment, foreign exchange payment, etc.), an account of the recipient to which the payment will be debited, a cut-off time of the payment (e.g., a time by which the payment must be approved in order for the payment to be processed in time for the funds to be available to the recipient on the value date), a sender reference number, the date and time that the payment was initiated, or other suitable payment details. Although payment action pages 320 depict particular details regarding the initiated payments, any available details may be depicted in the payment action pages 320. For example, payment details depicted in FIG. 3B may be omitted, or other details may be included.

In various embodiments, portions of payment action page 320 may link to additional information. For example, selection of the “View Notes” area may display notes that have been entered regarding the payment. As another example, selecting the “Debit Account” area may display information regarding the debit account, such as the account balance of the debit account.

Payment action pages 320 may also include various options that allow the user that is actioning the payment to contact the initiator of the payment. The selection of phone button 328 may initiate a phone call to a phone (e.g., an office phone) of the payment initiator, the selection of mobile phone button 330 may initiate a phone call to a mobile phone of the payment initiator, the selection of button 332 may initiate a text message to the payment initiator, and the selection of button 334 may initiate an email to the payment initiator.

In particular embodiments, the payment details displayed by or accessible via the payment action pages 320 may be obtained through API calls to enterprise 104. In various embodiments, more than one API is called to obtain the payment details accessible through Payment action pages 320. For example, one API call may be sent to a first URL to obtain some of the details of payment action pages 320, while one or more other API calls may be sent to one or more other URLs to obtain the remainder of the details. As another example, separate API calls may be sent As an example, account balance information may be obtained through an API call sent to a URL associated with information reporting module 110, contact information of a payment initiator (made available through buttons 328, 330, 332, and 334) may be obtained through a call to a separate API that is sent to a URL associated with administrative module 112, and other payment details may be obtained through a call to another API that is sent to a URL associated with payment module 108. In particular embodiments, the results from an API call may be displayed in payment action page 320 while mobile device 102 waits to receive the results from the other API calls. Upon receipt of the remainder of the results, these results may be displayed along with the other details in payment action page 320 or may be made available via a link in payment action page 320.

In particular embodiments, the details displayed by or accessible through the payment action pages 320 are based on permissions associated with the user of mobile device 102. For example, enterprise 104 may determine which details of a payment a user may access based on an identifier of the user and transmit these details to mobile device 102 while blocking transmission of additional details that the user does not have permission to view. For example, a user may not have permission to view the balance of the account from which payment is to be made. In such a case, the balance would not be shown on payment action pages 320 generated for the user.

Upon generation of the queue of payment action pages 320, a payment action page 320 from the queue is selected and displayed by mobile device 102. The payment action page 320 that is displayed first may be determined in any suitable manner and in particular embodiments the order in which the payment action pages 320 are displayed is selectable by the user. For example, the payment action page 320a that corresponds to the same payment as the first summary 303a (or first selected summary 303) displayed by summary page 302 may be displayed first. As another example, the payment action page 320 that is the most urgent (e.g., has the least amount of time remaining before the cutoff time) may be displayed first.

In response to receiving a command from a user of mobile device 102 while the first payment action page 320a is displayed, a second payment action page 320b from the queue may be displayed. For example, selection of an approve button 322, reject button 324, or next button 336 may result in the display of the second payment action page 320b. As another example, a user may swipe a finger across a touch sensitive portion of mobile device 102 to display the second payment action page 320b. In particular embodiments, the second payment action page 320b may be displayed immediately after the user command is performed. In other embodiments, one or more intermediate pages may be displayed by mobile device 102 before the second payment action page 320b is displayed. For example, if a user selects the reject button 324, mobile device 102 may display a page that requests a reason for the rejection of the payment and after reception of this reason the second payment action page 320b may be displayed.

At step 210, payment actions for initiated payments are received. If a command to switch to the detailed view is not received at step 206, a user may action initiated payments from summary page 302 by selecting one or more payments via selection boxes 308 and then selecting an action button, such as approve button 310 or reject button 312. The selected action is then associated with the selected payments. If the command to switch to a detailed view is detected at step 206, then the queue of payment action pages 320 is generated and the user of mobile device 102 may iterate through a detailed view of each payment and apply actions to the payments. Any suitable payment action may be applied to an initiated payment. For example, in the embodiment depicted, selection of the approve button 322 results in an approval action being applied to the payment and selection of the reject button 324 results in a rejection action being applied to the payment. In other embodiments, a forward for approval action may be applied to one or more of the payments. For example, if the user decides that a different user should approve or reject the payment, the user may specify that the payment be forwarded to the other user. During review of the payment action pages 320, the user may also decide to skip the actioning of a payment and may move to the next payment action page 320 by selecting the next button 336. Any payments that are not actioned by the user may remain as pending and be included in subsequent summary pages 302 and payment action pages 320 generated by mobile device 102.

After the user is finished actioning the payments, a summary of payment actions is displayed at step 212. The user may indicate that actioning is complete in any suitable manner. For example, in the embodiment depicted in FIG. 3B, a user may indicate that actioning is complete by selecting finish button 326. In some embodiments, mobile device 102 may detect that a user is finished actioning upon selection of an action while the last payment action page 320 of the queue is displayed.

Any suitable summary of the payment actions entered by the user may be displayed. In the embodiment depicted in FIG. 3C, action summary page 340 groups payments by the applied payment actions. For example, the approved payments are listed under the heading “Submit to Bank,” a forwarded payment is listed under the heading “Route to Next Approver,” and a rejected payment is listed under the heading “Reject.” The summaries of the payments each include the template name of the payment and the amount of the payment. The rejected payment also includes the reason for the rejection of the payment. In particular embodiments, action summary page 340 also allows a user to select an actioned payment to view additional details about the payment. For example, the user may select the template name or other suitable portion of any of the actioned payments to view additional details associated with the payments. Any suitable details of the payments may be shown by action summary page 340. In particular embodiments, an actioned payment may be deleted from the action summary page 340 such that it is not submitted to the enterprise 104 along with the other actioned payments. For example, in the embodiment depicted, the user may delete an actioned payment by selecting the delete icon displayed on the right of each actioned payment. In particular embodiments, deleted actioned payments are placed back in the queue of initiated payments that are awaiting approval.

Action summary page 340 may provide various display options. For example, the view shown in action summary page 340 is an example view that may be displayed when the transactions tab 344 is selected. Action summary page 340 may also include a totals tab 346 that when selected results in display of amount totals. For example, the aggregate monetary amount of the approved transactions may be displayed, the aggregate monetary amount of the rejected transactions may be displayed, and the aggregate monetary amount of the forwarded transactions may be displayed.

At step 214, an instruction to submit the payment actions is received. For example, a user may select a submit payments button 348 of action summary page 340 or otherwise indicate that the payment actions should be submitted to enterprise 104. In particular embodiments, the user may be prompted for a passcode via passcode field 342. The passcode may ensure that only authorized users submit payment actions to enterprise 104 via mobile device 102.

At step 216, it is determined whether the payment actions have been transmitted to enterprise 104. If it is determined that they have not, the method may return to any suitable step of the method, such as the display of the action summary page 340 at step 212. If it is determined that the payment actions have been transmitted to enterprise 104, a submission confirmation page 360 is displayed by mobile device 102 at step 218. As depicted in FIG. 3D, submission confirmation page 360 may include a submission confirmation field 362 that indicates that the payment actions were successfully submitted to enterprise 104. Such confirmation may be useful because if mobile device 102 loses its connection to network 106 through loss of signal or power during transmission of the payment actions, a user may not know whether the payment actions were successfully submitted in the absence of such confirmation. In such a situation, a user may be reluctant to submit the payments again out of a fear that a payment may be made twice. In some applications lacking a submission confirmation page 360, a user may have to wait until the payment is processed by the bank to determine whether the transmission of the payment action was successful. This delay may be unacceptable due to the potential lag in time between submission of a payment action and the processing of the payment according to the action and the risk of late payments if it turns out that the actions were not transmitted. The submission confirmation page 360 may also enable a user to confirm submission without having to navigate within an application to find submitted transactions. Submission confirmation page 360 may include any suitable information about payments 366 that have been submitted to enterprise 104. In a particular embodiment, submission confirmation page 360 displays the payments 366 that have been submitted on a particular day. Submission confirmation page 360 may include an ordering button 364 that allows payments 366 to be sorted by any suitable criteria.

After display of the submission confirmation at step 218, the method ends. Modifications, additions, or omissions may be made to the method. The method may include more, fewer, or other steps. Additionally, steps may be performed in parallel or in any suitable order. Any suitable component of system 100 may perform one or more steps of the method.

Modifications, additions, or omissions may be made to the pages depicted in FIGS. 3A-3D. For example, summaries 303, payment approval pages 320, payment action page 340, and submission confirmation page 360 may include more or less payment details, or payment details that are different from those depicted.

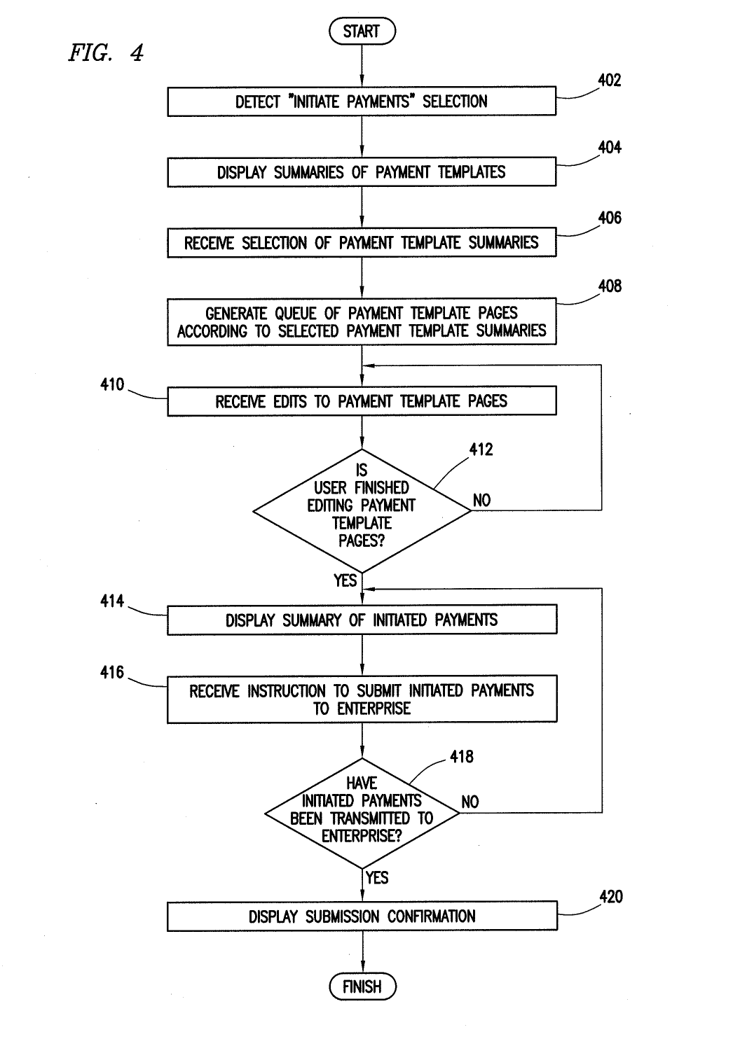

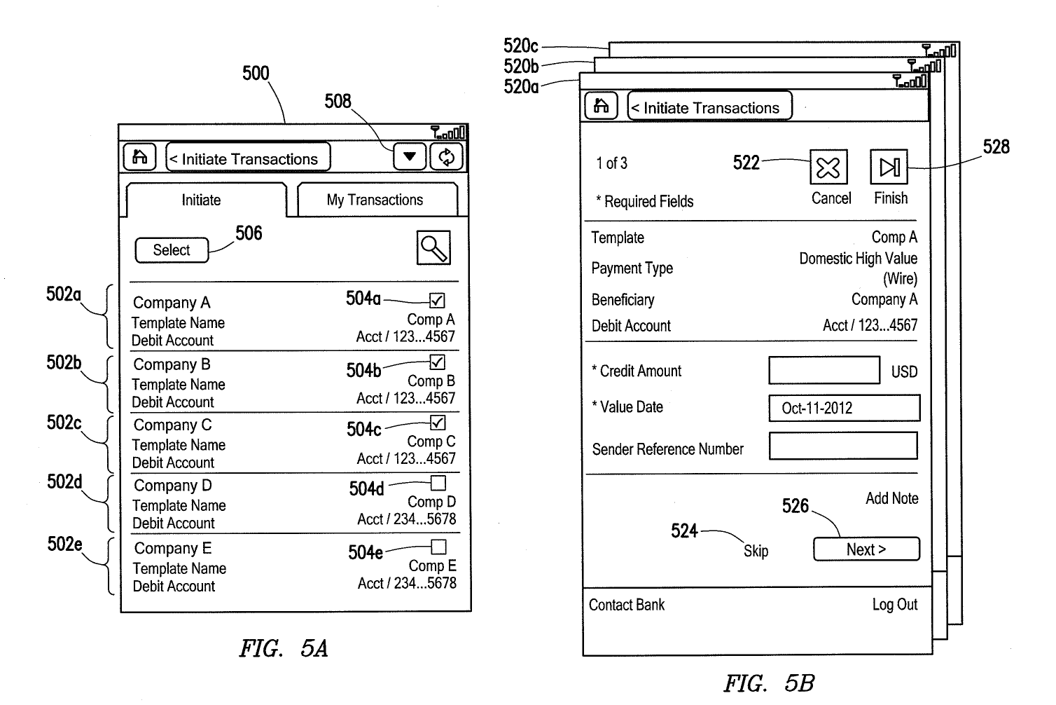

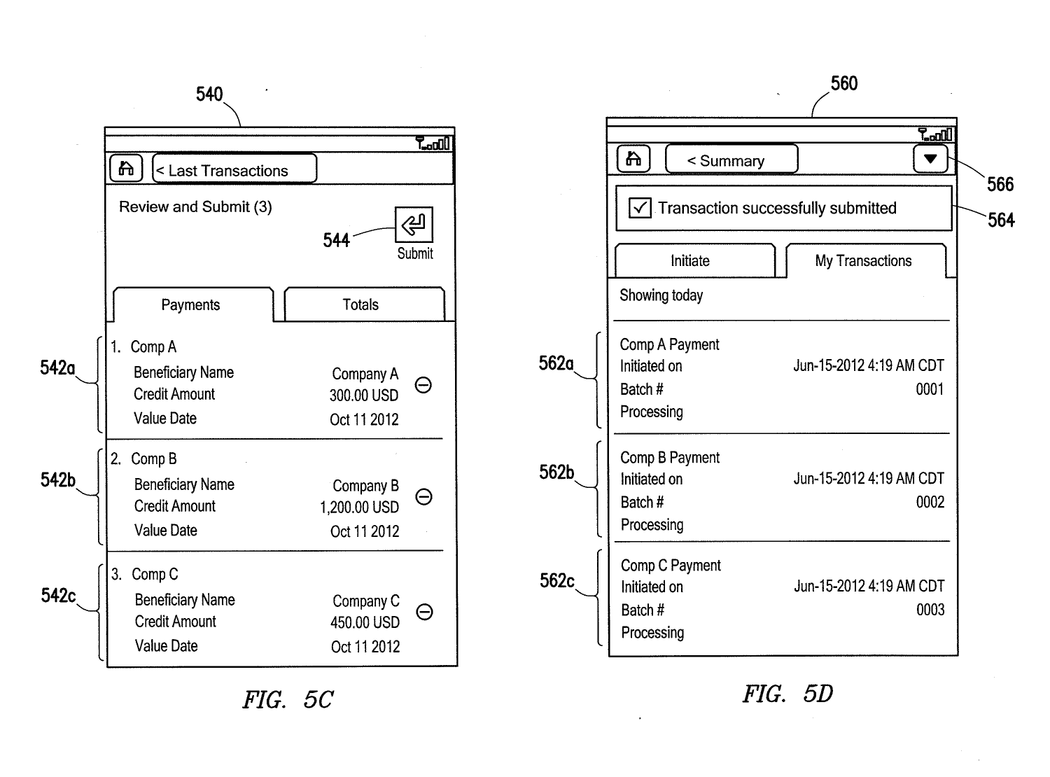

FIG. 4 illustrates an example method for facilitating the generation of a payment template page queue that may be performed by mobile device 102. The method will be explained in connection with FIGS. 5A-5D which illustrate example pages that may be displayed by mobile device 102. The method begins at step 402, where an “initiate payments” selection is detected. As described above, mobile device 102 may execute a mobile banking application that allows a user to select various mobile banking functions, including an “initiate payments” function. Upon selection of the “approve transactions” function, mobile device 102 may identify payment templates that may be used to initiate payments. The mobile device 102 may identify these payments in any suitable manner. In particular embodiments, the mobile device may send one or more API calls requesting the payment templates to enterprise 104 in response to the selection of the “initiate payments” function. Enterprise 104 may then transmit the payment templates to mobile device 102. In other embodiments, the payment templates may be received from enterprise 104 prior to the selection.

At step 404, summaries of the identified payment templates are displayed. For example, mobile device 102 may display the summaries in a page such as template summary page 500 of FIG. 5A. Template summary page 500 includes summaries 502a-502e of payment templates. Template summary page 500 may include any suitable number of summaries 502. In the embodiment depicted, additional summaries 502 may be viewed by scrolling down on template summary page 500. Each summary 502 includes a subset of details associated with the corresponding payment template. For example, in the embodiment depicted, summary 502a includes a payment recipient, a name of the template, and an account from which payment is to be made. Although summaries 502 depict particular details associated with the payment templates, any subset of available details may be depicted in the summaries. Summaries 502 may be displayed in any suitable order. In the embodiment depicted, a user may select an ordering button 508 and choose a desired order from a pull-down menu. For example, summaries 508 may be displayed in order of payment recipient, debit account, or other suitable detail associated with the corresponding payments. In particular embodiments, the order may be based on group names associated with the payment templates. For example, some templates may be in an “Asian” group, other templates may be in a “European” group, and so on where the group name denotes a country of the payment recipient.

At step 406, a selection of payment template summaries is received. As an example, a user may select various templates via selection boxes 504 or using other suitable methods. After identifying the desired payment templates, the user may confirm his choice in any suitable manner. For example, the user may use select button 506 to confirm the choice of payment templates.

At step 408, a queue of payment template pages is generated according to the selected payment template summaries. For example, in the embodiment depicted in FIG. 5B, a queue includes payment template pages 520a-520c. Payment template page 520a corresponds to payment template summary 502a, payment template page 520b corresponds to payment template summary 502b, and payment template page 520c corresponds to payment template summary 502a. In particular embodiments, a payment template page 520 is generated based on the underlying payment template of each selected payment template summary 502. In some embodiments, template summary page 500 may allow a user to indicate a quantity of a particular payment template summary, such that multiple payment template pages 520 may be generated based on a particular payment template.

Each payment template page 520 includes a detailed view of the details associated with the corresponding payment template. In particular embodiments, the payment template pages 520 include payment details associated with the payment template that are not included in the corresponding payment template summary 502. In particular embodiments, payment template pages 520 include all of the details included in payment template summaries 502 in addition to other details associated with the corresponding payment templates.

As in the example payment template summaries 502 described above, payment template page 520 may include a name of the template, a name of the recipient of the payment, and an account from which the payment is to be made. A payment template page 520 may also include a payment type that describes how the payment will be transferred to the recipient, input fields for the payment amount, the value date of the payment, and a sender reference number, or any other suitable payment information. Although payment template pages 520 depict particular details regarding the payment templates, any available details may be depicted in the payment template pages 520. For example, payment details depicted in FIG. 5B may be omitted, or other details may be included.

In various embodiments, portions of payment template page 520 may link to additional information. For example, selecting the “Debit Account” area may display information regarding the debit account, such as the account balance of the debit account. As another example, selecting the “Beneficiary” area may display information regarding the payment recipient, such as contact information associated with the recipient. As another example, payment template page 520 may allow the user to access contact information of one or more designated reviewers of payments created using a particular template.

In particular embodiments, the payment details displayed by or accessible via the payment template pages 520 may be obtained through API calls to enterprise 104. In various embodiments, more than one API is called to obtain the payment details accessible through payment template pages 520. For example, one API call may be sent to a first URL to obtain some of the details of payment template pages 520, while one or more other API calls may be sent to one or more other URLs to obtain the remainder of the details. As an example, account balance information may be obtained through an API call sent to a URL associated with information reporting module 110, contact information of a payment reviewer or a payment recipient may be obtained through a call to a separate API that is sent to a URL associated with administrative module 112, and other payment details may be obtained through a call to another API that is sent to a URL associated with payment module 108. In particular embodiments, the results from an API call may be displayed in payment template page 520 while mobile device 102 waits to receive the results from the other API calls. Upon receipt of the remainder of the results, these results may be displayed along with the other details in payment template page 520 or may be made available via a link in payment template page 520.

In particular embodiments, the details displayed by or accessible through the payment template page 520 are based on permissions associated with the user of mobile device 102. For example, enterprise 104 may determine which details of a payment template a user may access based on an identifier of the user and transmit these details to mobile device 102 while blocking transmission of additional details that the user does not have permission to view. For example, a user may not have permission to view the balance of the account from which payment is to be made. In such a case, the balance would not be shown on payment template pages 520 generated for the user.

Upon generation of the queue of payment template pages 520, a payment template page 520 from the queue is selected and displayed by mobile device 102. The payment template page 520 that is displayed first may be determined in any suitable manner. For example, the payment template page 520a that corresponds to the same payment as the first selected payment template summary 504a of payment template summary page 500 may be displayed first.

In response to receiving a command from a user of mobile device 102 while the first payment template page 520a is displayed, a second payment action page 320b from the queue may be displayed. For example, selection of a skip button 524 or a next button 526 may result in the display of the second payment template page 520b. As another example, a user may swipe a finger across a touch sensitive portion of mobile device 102 to display the second payment template page 520b. Accordingly, a user may iterate through the queue of payment template pages 520 in order to quickly create a plurality of payments.

At step 410, edits to the payment template pages 520 are received. As an example, a user may enter an amount and a currency type in the “Credit Amount” field. Particular embodiments allow payments to be specified in any suitable currency. Accordingly, particular embodiments include a single mobile banking application that may be used to initiate payments to recipients located in various different countries. As further example of edits that may be made to payment template pages 520, a user may enter a value date or a sender reference number. Upon completion of the editing of a payment template page 520, the user may move to the next payment template page 520 by selecting the next button 526, swiping the screen, or by performing any other suitable action. A user may skip a payment template page 520 by selecting the skip button 524. A user may also cancel out of the editing process by selecting the cancel button 522.

At step 412, it is determined whether the user is finished editing payment template pages 520. If it is determined that the editing is not complete, mobile device 102 may continue to receive edits to payment template pages 520 from the user. If it is determined that the user is finished editing payment template pages 520, the method moves to step 414. Any suitable method may be used to determine whether editing is complete. For example, mobile device 102 may detect that a user has selected finish button 528, thereby indicating the user is finished editing payment template pages 520. In some embodiments, mobile device 102 may detect that a user is finished editing upon an action (such as selecting the next button 526 or swiping the screen) performed while the last payment template pages 520 of the queue is displayed.

After the user is finished editing the payment template pages 520, a summary of initiated payments is displayed at step 414. An initiated payment may be generated for each payment template page 520 in which the user has entered the requisite information. In particular embodiments, the requisite information includes a monetary amount of the desired payment and a value date (which may be auto-filled by mobile device 102 or entered by the user). In other embodiments, any other suitable information may be required. An initiated payment includes the payment details associated with the payment template in addition to payment details (e.g., monetary amount, value date) entered by the user during editing of the corresponding payment template page 520.

Any suitable summary of the payment actions entered by the user may be displayed at step 414. In the embodiment depicted in FIG. 5C, initiated payments summary page 540 displays the template name, recipient of the payment, amount of the payment, and the value date of each initiated payment 542. In particular embodiments, initiated payments summary page 540 also allows a user to select an initiated payment to view additional details about the payment. For example, the user may select the expander icon to the right of any of the initiated payments 542 to view additional details associated with the payments. Any suitable details of the payments may be shown by initiated payments summary page 540.

Initiated payments summary page 540 may provide various display options. For example, the view shown in FIG. 5C is an example view that may be displayed when the payments tab is selected. Initiated payments summary page 540 may also include a totals tab that displays amount totals. For example, the aggregate monetary amount of the initiated payments may be displayed via the totals tab. Totals may be shown for any suitable grouping of the initiated payments, such as value date, payment recipient, template group, or other grouping.

At step 416, an instruction to submit the initiated payments to enterprise 104 is received. For example, a user may select a submit button 544 of initiated payments summary page 540 or otherwise indicate that the initiated payments should be submitted to enterprise 104.

At step 418, it is determined whether the initiated payments have been transmitted to enterprise 104. If it is determined that they have not, the method may return to any suitable step of the method, such as the display of the initiated payments summary page 540 at step 414. If it is determined that the initiated payments have been transmitted to enterprise 104, a submission confirmation page 560 is displayed by mobile device 102 at step 420. As depicted in FIG. 5D, submission confirmation page 560 may include a submission confirmation field 564 that indicates that the initiated payments were successfully submitted to enterprise 104. Submission confirmation page 560 may include any suitable information sets 562 about initiated payments that have been submitted to enterprise 104. Submission confirmation page 560 may include an ordering button 566 that allows information sets 562 to be sorted by any suitable criteria.

After display of the submission confirmation at step 420, the method ends. Modifications, additions, or omissions may be made to the method. The method may include more, fewer, or other steps. Additionally, steps may be performed in parallel or in any suitable order. Any suitable component of system 100 may perform one or more steps of the method.

Modifications, additions, or omissions may be made to the pages depicted in FIGS. 5A-5D. For example, payment template summary page 500, payment template pages 520, initiated payments summary page 540, and submission confirmation page 560 may include more or less payment details, or payment details that are different from those depicted.

Certain embodiments of the invention may provide one or more technical advantages. A technical advantage of one embodiment includes efficient communication between a mobile device and an enterprise by transmission of initiated payments in groups. Another advantage includes queuing a plurality of payment template pages to facilitate payment initiation. Another advantage includes loading information from multiple different application programming interface (API) calls into a single payment template page. Another advantage includes reducing network bandwidth used by extraneous submissions by immediately notifying a user that a group of initiated payments has been submitted to an enterprise.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

1. An apparatus, comprising:
a processor operable to:
display a plurality of payment template summaries simultaneously on a mobile device, a payment template summary corresponding to a payment template and including a subset of a plurality of payment details associated with the payment template; and
an interface communicatively coupled to the processor and operable to:
receive a selection of two or more of the plurality of payment template summaries;
wherein the processor is further operable to:
generate a queue comprising a plurality of payment template pages according to the selection, a payment template page comprising the plurality of payment details associated with the payment template that corresponds to a selected payment template summary;
display on the mobile device a first payment template page of the plurality of payment template pages of the queue; and
receive a monetary amount at the first payment template page from a user of the mobile device and generate an initiated payment for the monetary amount, the initiated payment including the plurality of payment details of the first payment template page.

2. The apparatus of claim 1, the processor further operable to display on the mobile device a second payment template page of the plurality of payment template pages of the queue in response to user input received during display of the first payment template page.

3. The apparatus of claim 1, wherein the plurality of payment details of a payment template page include a payment recipient and an account from which the initiated payment is to be debited.

4. The apparatus of claim 1, the processor further operable to generate and display a payment summary page in response to a user action received while a payment template page of the plurality of payment template pages is displayed on the mobile device, the payment summary page including a plurality of summaries of initiated payments.

5. The apparatus of claim 1, wherein the interface is further operable to transmit the initiated payment to an enterprise for processing and wherein the processor is further operable to, in response to the transmission, display a confirmation that the initiated payment has been submitted to the enterprise.

6. The apparatus of claim 1, wherein one or more first payment details of the plurality of payment details of the first payment template page are received from a first server of an enterprise via a first application programming interface (API) and one or more second payment details of the plurality of payment details of the first payment template page are received from a second server of the enterprise via a second API.

7. The apparatus of claim 6, wherein the one or more first payment details are displayed in the first payment template page before the one or more second payment details are received from the second server of the enterprise.

8. A non-transitory computer readable medium comprising logic, the logic, when executed by a processor, operable to:
display a plurality of payment template summaries simultaneously on a mobile device, a payment template summary corresponding to a payment template and including a subset of a plurality of payment details associated with the payment template;
receive a selection of two or more of the plurality of payment template summaries;
generate a queue comprising a plurality of payment template pages according to the selection, a payment template page comprising the plurality of payment details associated with the payment template that corresponds to a selected payment template summary;
display on the mobile device a first payment template page of the plurality of payment template pages of the queue; and
receive a monetary amount at the first payment template page from a user of the mobile device and generate an initiated payment for the monetary amount, the initiated payment including the plurality of payment details of the first payment template page.

9. The computer readable medium of claim 8, the logic further operable to display on the mobile device a second payment template page of the plurality of payment template pages of the queue in response to user input received during display of the first payment template page.

10. The computer readable medium of claim 8, wherein the plurality of payment details of a payment template page include a payment recipient and an account from which the initiated payment is to be debited.

11. The computer readable medium of claim 8, the logic further operable to generate and display a payment summary page in response to a user action received while a payment template page of the plurality of payment template pages is displayed on the mobile device, the payment summary page including a plurality of summaries of initiated payments.

12. The computer readable medium of claim 8, the logic further operable to:
transmit the initiated payment to an enterprise for processing; and
in response to the transmission, display a confirmation that the initiated payment has been submitted to the enterprise.

13. The computer readable medium of claim 8, wherein one or more first payment details of the plurality of payment details of the first payment template page are received from a first server of an enterprise via a first application programming interface (API) and one or more second payment details of the plurality of payment details of the first payment template page are received from a second server of the enterprise via a second API.

14. The computer readable medium of claim 13, wherein the one or more first payment details are displayed in the first payment template page before the one or more second payment details are received from the second server of the enterprise.

15. A method comprising:
displaying a plurality of payment template summaries simultaneously on a mobile device, a payment template summary corresponding to a payment template and including a subset of a plurality of payment details associated with the payment template;
receiving a selection of two or more of the plurality of payment template summaries;
generating, by a processor, a queue comprising a plurality of payment template pages according to the selection, a payment template page comprising the plurality of payment details associated with the payment template that corresponds to a selected payment template summary;
displaying on the mobile device a first payment template page of the plurality of payment template pages of the queue; and
receiving a monetary amount at the first payment template page from a user of the mobile device and generate an initiated payment for the monetary amount, the initiated payment including the plurality of payment details of the first payment template page.

16. The method of claim 15, further comprising displaying on the mobile device a second payment template page of the plurality of payment template pages of the queue in response to user input received during display of the first payment template page.

17. The method of claim 15, wherein the plurality of payment details of a payment template page include a payment recipient and an account from which the initiated payment is to be debited.

18. The method of claim 15, further comprising generating and displaying a payment summary page in response to a user action received while a payment template page of the plurality of payment template pages is displayed on the mobile device, the payment summary page including a plurality of summaries of initiated payments.

19. The method of claim 15, further comprising:
transmitting the initiated payment to an enterprise for processing; and
in response to the transmission, displaying a confirmation that the initiated payment has been submitted to the enterprise.

20. The method of claim 15, wherein one or more first payment details of the plurality of payment details of the first payment template page are received from a first server of an enterprise via a first application programming interface (API) and one or more second payment details of the plurality of payment details of the first payment template page are received from a second server of the enterprise via a second API.

21. The method of claim 20, wherein the one or more first payment details are displayed in the first payment template page before the one or more second payment details are received from the second server of the enterprise.
